(19) United States
(12) Patent Application Publication
(10) Pub. No.: US 2012/0179585 A1
(43) Pub. Date: Jul. 12, 2012

(54) Method and System for Laboratory Asset Identification and Management

(75) Inventors: Judith Ann Guzzo, Niskayuna, NY (US); Lynn Ann DeRose, Gloversville, NY (US); Li Zhang, Niskayuna, NY (US); Fraser Black, Kinross (GB); Michael James Benevento, Princeton, NJ (US); Mark Magarelli, Manalapan, NJ (US); Eric D. Williams, Duanesburg, NY (US)

(73) Assignee: General Electric Company, Schenectady, NY (US)

(21) Appl. No.: 12/985,779

(22) Filed: Jan. 6, 2011

(51) Int. Cl. G06Q 10/00; G06F 17/00; H04Q 5/22

(52) U.S. Cl. 705/28; 340/10.1; 235/385

(57) ABSTRACT

The present disclosure relates approaches that may be used to manage research assets, such as equipment and consumable items. In certain implementations, asset information from multiple input sources is stored in a database or other mass storage device and may be used to provide a report of the real time condition of any individual research asset. In further implementations, the information may be used to provide indications or reminders associated with an individual research asset, such as maintenance reminders.

### BACKGROUND OF THE INVENTION

The subject matter disclosed herein relates to identification and inventory management for laboratory and research assets. In particular, the disclosed embodiments relate to systems and methods for tracking the location, status, and/or use of equipment and consumable items used in laboratory research.

Laboratory research involves significant investment in both equipment assets and consumable assets. For example, an individual laboratory space may have several pieces of shared large equipment, such as storage equipment (e.g., freezers) and analytical instruments, as well as a supply of consumable items (e.g., chemicals, buffers, pipette tips) that are available to the researchers. In addition, a single laboratory may be made up of several workstations, which are separately equipped with their own small research tools and consumable items. Because research is often collaborative, equipment and consumable items are often shared or exchanged between researchers and, at times, may be shared between laboratories.

It is desirable to allow scientists to access supplies and equipment needed for research without imposing onerous gateway controls. However, because laboratory assets can be expensive, it is also desirable to track these assets to maintain inventory control and minimize excess inventory and equipment downtime.

### BRIEF DESCRIPTION OF THE INVENTION

Provided herein are methods and systems of laboratory asset management that include receiving (and/or storing) asset information related to equipment or consumable items from a variety of sources. The information is bundled in a database or other mass storage and may be used to provide a report of the condition of any individual research asset.

In one embodiment, a method is provided for receiving information from a manual input, an active or passive radiofrequency tag, a barcode, a sensor, or a networked computer, wherein the information is related a location, a status, or a use for each of a plurality of research assets, and wherein the plurality of research assets comprise equipment items and consumable items; adding the information to a database comprising identification information for each of the plurality of research assets; accessing the database to identify a portion of the plurality of research assets in need of an action; and providing an output related to the action

In a further embodiment, one or more non-transitory computer-readable media are provided. The computer-readable media comprise one or more routines which, when executed by a processor, perform acts comprising storing information from a manual input, an active or passive radiofrequency tag, a barcode, a sensor, or a networked computer, wherein the information is related a location, a status, or a use for each of a plurality of research assets, and wherein the plurality of research assets comprise equipment items and consumable items; accessing the information to determine a condition of the plurality of research assets based at least in part on the information; and providing an output related to the condition of the plurality of research assets

In an additional embodiment, a method is provided for tracking research assets, the method comprising: receiving information related a location, a status, or a use for each of a plurality of research assets, wherein the plurality of research assets comprise equipment items and consumable items and wherein the information is received from a plurality of inputs comprising an active or passive radiofrequency tag and an environmental sensor; determining respective use patterns for the plurality of research assets; and identifying underutilized research assets based on the respective use patterns

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 depicts an example of organization of laboratory assets in a research center with a research asset management system;

FIG. 2 depicts examples of inputs to a research asset management system, in accordance with aspects of the present disclosure;

FIG. 3 depicts an example of an information display screen for an individual research asset that may be generated by a research asset management system, in accordance with aspects of the present disclosure;

FIG. 4 is a flowchart depicting steps by which a condition report for research assets is generated from asset information, in accordance with aspects of the present disclosure; and

FIG. 5 is a flowchart depicting steps by which a condition report for research assets is generated from environmental sensor information, in accordance with aspects of the present disclosure.

### DETAILED DESCRIPTION OF THE INVENTION

One or more specific embodiments will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related, regulatory and/or business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Further, each example or embodiment is provided to facilitate explanation of certain aspects of the invention and should not be interpreted as limiting the scope of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present disclosure covers such modifications and variations as come within the scope of the appended claims and their equivalents.

The present disclosure relates to management of research assets or research facilities. In particular implementations, the research asset information is gathered into a centralized system that may bundle information obtained from a variety of different input mechanisms (e.g., manual input, historical records, passive or active tags). This information may be used to provide real-time assessment of the assets for the purposes of load balancing, maintenance, redeployment, equipment sharing, decommissioning, and minimizing downtime. Particular types of sensor technologies may be used to provide automated input to the asset management system for determining the status or condition of a research asset. In addition, the system provides the advantage of collecting information and/or data from multiple sources to provide more in-depth assessments of research assets. Certain types of inputs may provide location information, while other types of inputs provide status information or maintenance information. By combining all of the available inputs within the system, a location, history, usage, condition, and/or health of particular asset or a group of assets may assessed.

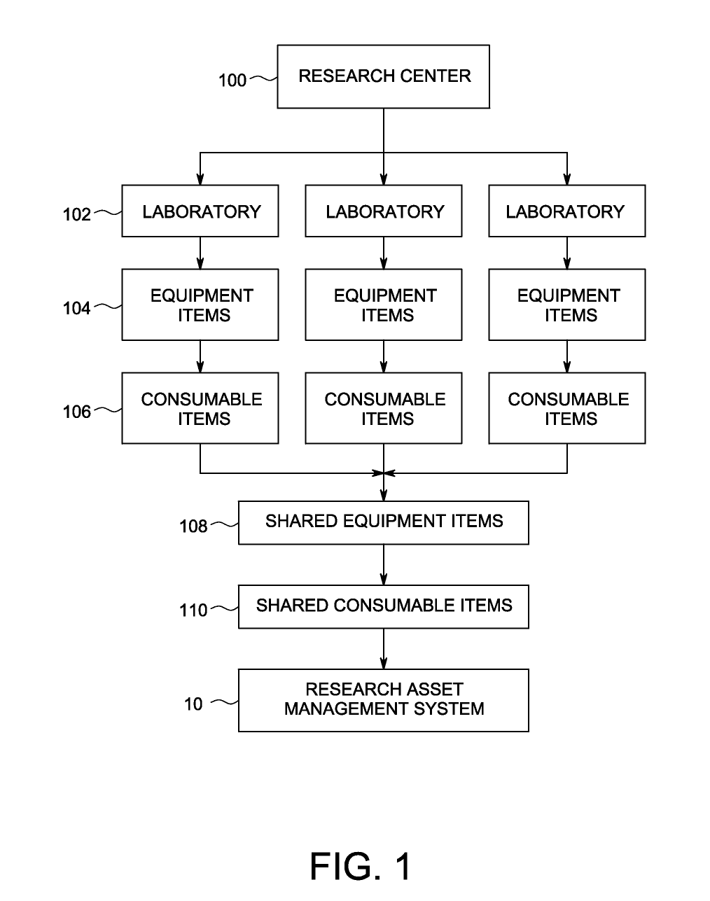

It is envisioned that the asset management systems and associated techniques may be provided to customers or end-users at any suitable type of research facility, including corporate research facilities, academic laboratories, or government institutions. FIG. 1 is a block diagram showing a research asset management system 10 associated with an exemplary research center 100. It should be understood that the research center 100 may be housed within a single building or research campus or may include facilities distributed between several different locations (e.g., different campuses, cities, or countries). Further, a single research asset management system 10 may be used to track assets for a plurality of different research programs. In one implementation, individual research assets may be grouped together depending on their funding source or research department.

In the depicted embodiment, the research center is made up of one or more laboratories 102, which each have a dedicated set of research assets that include separate equipment items 104 and consumable items 106. In addition, a group of laboratories 102 may also have shared equipment items 108 and shared consumable items 110 between them. The laboratories 102 may be multipurpose laboratories or may be specialized (e.g., hot rooms or cell culture rooms shared between several researchers primarily associated with multipurpose laboratories 102). Equipment items 104 and shared equipment items 108 may include any instruments or tools used for scientific research. Further, equipment may include stand-alone equipment, small tools, analytical instruments, safety items, and storage devices. In particular embodiments, equipment items 104 and 108 may include freezers, refrigerators, analytical balances, rotovaps, centrifuges, mills, analytical instruments, HPLC, optical analyzers, mass spectrometers, pH meters, heaters, ovens, spinners, water baths, incubators, purification systems (e.g., columns), synthesizers, autoclaves, PCR machines, gel electrophoresis systems, vent hoods, tissue culture hoods, cell counters, pipetters, and glassware. Further, in particular embodiments, certain equipment items 104 and 108 may include operating systems, such as computers or other user input devices. Consumable items 106 and shared consumable items 110 may include chemicals, liquids, gases, scientific reagents, radioactive materials, glassware, plates, animal handling items, electrophoresis accessories, kits, cell culture supplies, and laboratory cleaning supplies and safety supplies. It should be understood that the listed examples of equipment items (e.g., equipment items 104 and 108) and consumable items (e.g., consumable items 106 and shared consumable items 110) are merely for illustrative purposes and are not an exhaustive list.

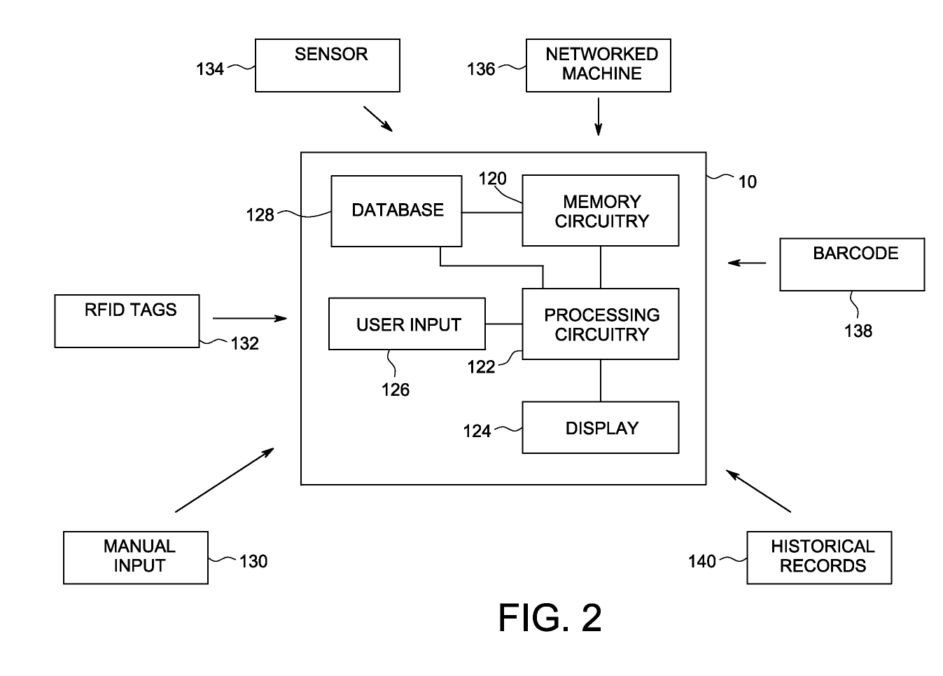

FIG. 2 is a block diagram of the research asset management system 10. As noted, research asset management system 10 is capable of receiving and storing asset information obtained from a variety of different types of input sources. In certain embodiments, the inputs may be provided to a networked computer or network server, which in turn may communicate the information to the research asset management system 10. This information is stored in memory circuitry 120 and may be accessed for further processing by processing circuitry 122. In particular embodiments, the memory storage and 120 and processing circuitry 122 of the research asset management system 10 access a database 128 of asset information and implement report generation processing circuitry. The research asset management system 10 and associated components (e.g., memory circuitry 120 and processing circuitry 122) may include a computer, a disk drive, hard drive, CD player or network server, mass storage, and/or tangible machine-readable media. The processor circuitry 122 may include, for example, general-purpose single- or multi-chip microprocessors. In addition, the processing circuitry 122 may be any conventional special purpose processor, such as an application-specific processor or circuitry. In addition, a display 124 may provide indications to the user related to research asset condition, status, use, or location. The research asset management system 10 includes a user input device 126 (e.g., a keyboard, mouse, touchscreen, trackball, hand held device such as PDA or smart phone or any combination thereof) for manipulating the research asset information on the display 124. In addition, the user input device 126 may be used to input information, such as via manual input 130.

The information related to the research assets may be bundled or collected by the research asset management system 10 to provide downstream outputs to the end user or decision maker. In one implementation, the research asset management system 10 is housed on a remote server, and the reports (e.g., condition reports) are delivered to customers via web agent and a web server, database servers, and/or application servers. Users can also access other pages on the same or other database servers by following instructions on the screen, entering certain data, or clicking on selected icons. It should also be noted that any type of selection device known to those skilled in the art, such as check boxes, drop-down boxes, and the like, may be used for embodiments of the invention using web pages to allow a user to select options for a given task. In such embodiments, the research asset management system 10 includes one or more communication links to the internet, such as a wireless communication system or a landline communication system, which may be used to form a communication link between the research assets and the research asset management system 10 and between the users and the research asset management system 10.

The research asset management system 10 may also include appropriate security and control measures. For example, members of an individual laboratory 102 may be able to access only the assets associated with that particular laboratory 102, department heads may be able to access only the group of laboratories 102 in their charge, and facility heads may be able to access only the group of laboratories 102 in their particular facility. Security controls may include username/password security controls, which may be linked to the appropriate dataset(s) and levels of access for the user. In addition, security controls may dictate the level of manual input 130 allowed for entering asset data into the research asset management system 10.

In addition to manual inputs, the research asset management system 10 is capable of receiving automatic input from active or passive radiofrequency identification (RFID) tags 132 that are associated with research assets. For example, the research asset management system 10 may perform automatic scheduled scans for RFID tags 132, or may receive transmitted information from active tags. Information from RFID tags 132 may be used to track inventory or assess location of particular research assets. Information from multiple RFID tags 132, and/or other types of location tagging, may be used to triangulate location to provide greater accuracy.

In a particular implementation, asset information may be also received from one or more sensors 134. For example, the sensors 134 may be part of a distributed network or a mesh ad-hoc wireless network. In one implementation, the sensors 134 may communicate via a ZIGBEE® communication scheme that uses the IEEE 802.15.4 standard supporting short-range communication. The ZIGBEE® communication protocol for a Wireless Personal Area Network (WPAN) may be used for 10 to 20-meter communication in a wireless network environment. In particular, the ZIGBEE® communication scheme provides a short-range and low-power communication scheme that may be suitable for environmental or other sensors 134 associated with research assets.

Information related to research assets may also be received from one or more networked computers 136. For example, certain types of equipment items 104 may be associated with dedicated networked computers 136, which may provide log files and other use information to the research asset management system 10. Other input sources may include barcodes 138 or historical records 140 (e.g., maintenance records or calibration records, procurement records, assignment records).

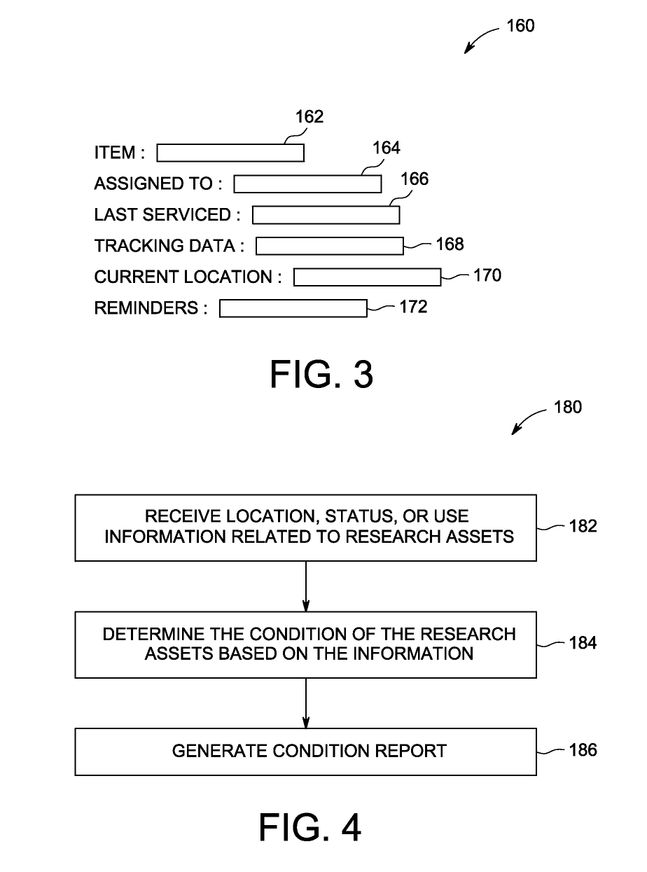

The research asset management system 10 is capable of generating reports or other indications to an end user related to the research assets. The report generation may include a report generation module that is programmable to produce customized or formatted outputs, such as the display screen 160 depicted in FIG. 3. Reports may be generated as a function of asset type, individual laboratory 102, location, assignment (e.g., user), usage, and condition. As shown, a report may include identification information 162, assignment information 164, maintenance information 166, historical information, such as location tracking data 168, a current location 170, and information or reminders 172 about any upcoming or overdue actions. For example, the depicted screen may be appropriate for a small research tool, such as a pipette gun, that is assigned to an individual researcher. Because such tools are small, it may be useful to track current location 170 and location over a past time period (e.g., tracking data 168) to determine usage. In addition, because such tools require regular maintenance and calibration, the report may include a tab for maintenance reminders or other actions. In other embodiments, automatic reminders (e.g., email or text message-based) may be sent to an end user, providing information about scheduled maintenance, asset location, or other information. The depicted report screen is just one example of an end user report. In other embodiments, a report may be tailored to a larger, more complex device. Such a device may have more limited tracking information, because movement is less likely for a larger device, but may have additional associated information received from environmental sensors.

The research asset management system 10 may also be capable of collecting information from disparate sources to create reports for individual research assets as well as groups of assets. For example, an end user may wish to assess inventory and equipment usage for an individual laboratory 102. FIG. 4 is a flow diagram of a method 180 of assessing research asset condition, which may include location, status, deployment, usage, downtime, or health of research assets. At step 182, the research asset management system 10 receives information from input sources related to the assets in question. The condition of the research assets may be determined at step 184 based in the information. For example, if the received information includes assignment information, location information, information from log files of a networked computer, identification information, and maintenance information, conditions for a group of research assets assigned to an individual laboratory 102 or research facility 100 may be determined. Such information may be provided as part of a condition report at step 186. In other embodiments, the reports may be tailored for a specific purpose or agency. For example, a condition report may be generated to track items associated with a particular regulatory process (e.g., FDA approval). In other embodiments, the condition of the research assets may be used to determine if a contract or rental agreement is ready for expiration and/or renewal. For example, particular equipment items 104 may be rented for a set period of time and/or a set number of uses. When a particular equipment item 104 has exceeded a contractually-determined amount of time or number of uses, an indication may be sent to one or both of the renter and the equipment provider. Such indications may include reminders or instructions for contract renewal.

In one embodiment, the report may include information about any equipment items 104 or consumable items 106 that have moved out of their respective assigned locations. In addition, based on the usage information, the report may include recommendations for asset utilization (e.g., redeployment or redistribution) based on patterns of underuse or overuse. Further, the report may provide recommendations on workspace assignment based on usage patterns. For relatively expensive machines that are used infrequently, the identified users of such machines may be grouped together in a single workspace for more effective utilization. In contrast, for machines that are indicated to be overused, workspaces may be divided so that infrequent users of such machines are grouped in with frequent users to avoid backup. The condition report may also provide a list of outstanding actions, such as maintenance actions, and a list of upcoming or scheduled actions.

Certain types research asset information may be automatically collected and analyzed to identify areas of inefficiency or possible improvement. For example, tracking information may be collected every hour, every day, every week, and/or every month. In addition, condition reports may be updated for every instance of new collected information associated with a particular research asset. In other embodiments, tracking information may be collected in a motion-triggered manner. If the tracking information is as expected (e.g., does not deviated from an assigned location), the condition report may remain as stored data. However, in an instance of deviation, the report or other type of indication may be forwarded to an end user.

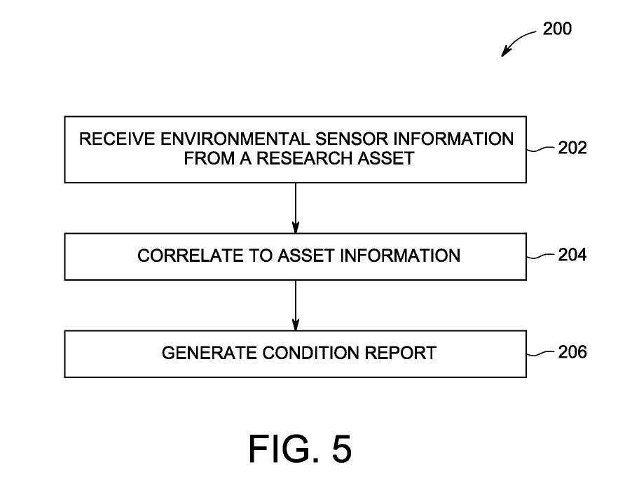

In a particular implementation, a condition report may be generated based on information from one or more sensors associated with a research asset. FIG. 5 is a flow diagram of an example method 200 of assessing a condition of a research asset based at least in part on information obtained from environmental sensors (e.g., sensor 134). As provided, the research asset management system 10 may receive information, such as measurements, from one or more sensors associated with a research asset at step 202. The environmental sensor may be a temperature sensor, a light sensor, a humidity sensor, a gas sensor, a level sensor (e.g., an oil level sensor for a pump), a pressure sensor, a weight sensor, a volume sensor, a current or charge sensor, or a vibration sensor. In one implementation, a vibration sensor may be used to determine use of an equipment item, such as a shaker or a centrifuge. In addition, the vibration sensor may provide information to the research asset management system 10 related to the balance of a laboratory centrifuge. For example, a vibration sensor on or near an out-of-balance centrifuge may measure higher levels of vibration relative to a well-balanced centrifuge. The research asset management system 10 may track the amount of time spent out of balance to schedule appropriate maintenance. In addition, a laboratory centrifuge may experience higher vibrations during spin-up (starting) and spin-down (e.g., braking). In particular implementations, the measurements of the vibration sensor may track starting and stopping points for the centrifuge, which in turn may be used to assess usage.

In another implementation, a light or temperature sensor may be used to measure the usage of a lamp, such as a lamp associated with an optical device. Light or temperature information may be provided to the research asset management system 10 to track usage of a particular equipment item or to schedule light bulb replacements. For devices that rely on electrical power, current sensors may be employed to track usage. Temperature sensors may also provide monitoring information for air temperatures in the vicinity of sensitive equipment, materials (e.g., consumable items 106) or samples. Higher than normal oil temperatures in an oil reservoir of particular equipment items 104 may also be used to determine if the oil needs to be changed. In addition, environmental sensors may be used to track the status of consumable items. Pressure sensors may provide information about the fill level of gas tanks or oil tanks, and measurements from weight or strain sensors in association with container goods may be used to assess the amount of liquids or dry goods remaining.

At step 204, the information from the environmental sensor may be correlated to other asset information, such as identification information, information from additional sensors, tracking information, procurement information, or maintenance information. Based on the correlated information, a condition report may be generated at step 206. For example, the condition report may provide a name and location of a particular device, as well as recommendations for maintenance. If a lamp is not functioning properly, a replacement part order reminder may be generated that includes information about the location of the device in question and/or the researcher to whom the device has been assigned.

Technical effects of the invention include the use of computer-implemented processes, routines, and/or algorithms to analyze research asset condition, use, status, or location to more effectively distribute and maintain such assets. An additional technical effect of the invention includes the use of computer-implemented processes, routines, and/or algorithms to determine whether any research assets are in need of service or replacement. A further technical effect of the invention includes the use of computer-implemented processes, routines, and/or algorithms to make recommendations for redistribution of personnel based on the research assets information. A further technical effect is the collection of research asset information from a variety of sources into a computer-implemented process, routine, and/or algorithm to track and assess these assets.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method for asset identification, the method comprising:
receiving information pertaining to one or more facilities or research assets associated with one or more laboratories or research centers, wherein the information is related a location, a status, or a use for each of the facilities or research assets, and wherein the research assets comprise equipment items and consumable items;
adding the information to a database comprising identification information for each of the research assets;
accessing the database to identify a portion of the facilities or research assets in need of an action; and
providing an output related to the action.

2. The method of claim 1, wherein the information comprises input from a sensor; and determining a status or use of the equipment item based on the input from the sensor.

3. The method of claim 2, wherein the sensor comprises a temperature sensor, a light sensor or voltage sensor, and wherein determining the status or use comprises determining a status or a use of a light source associated with an individual equipment item.

4. The method of claim 3, wherein the output comprises an indication that the light source is in need of replacement.

5. The method of claim 2, wherein the sensor comprises a vibration sensor, and wherein determining the status or use comprises determining if the input from the vibration sensor is above a threshold.

6. The method of claim 5, wherein the output comprises an indication that an individual equipment item is out of balance.

7. The method of claim 2, wherein the sensor comprises a current sensor, and wherein determining the status or use comprises determining a length of time that a current of an individual equipment item has exceeded a threshold.

8. The method of claim 2, wherein the sensor comprises a pressure, weight, liquid, or volume sensor and wherein the output comprises an indication that an individual consumable item is in need of replacement.

9. The method of claim 1, wherein the output comprises an indication that an individual equipment item is in need of calibration.

10. The method of claim 1, wherein the output comprises an indication that an individual equipment item is in need of maintenance.

11. The method of claim 1, wherein the output comprises an indication related to an expiration or renewal of a contract or a rental agreement of an individual equipment item.

12.-20. (canceled)
